(19) United States
(12) Patent Application Publication
(10) Pub. No.: US 2011/0104418 A1
(43) Pub. Date: May 5, 2011

(54) PRE-MARKED BUILDING MATERIALS AND METHOD OF MANUFACTURE

(76) Inventor: Joseph Ryan Fish, Sykesville, MD (US)

(21) Appl. No.: 13/001,491

(22) PCT Filed: Jun. 25, 2009
(86) PCT No.: PCT/US2009/003786

§ 371 Date: Dec. 27, 2010

Related U.S. Application Data
(60) Provisional application No. 61/133,052, filed on Jun. 25, 2008.

(51) Int. Cl. B32B 3/10; B32B 1/08; G01B 3/02; B29B 11/10; B29C 47/92

(52) U.S. Cl. 428/36.9; 428/195.1; 428/34.1; 264/132; 425/171

(57) ABSTRACT

A length of rigid linear stock building material bearing along its exterior surface regular indicia of longitudinal distance from a reference point also on its exterior surface, such that an installer need only measure the length of the pipe run needed and may then immediately locate that position and cut the pipe to be installed to the desired length without the need to use a measuring device to transfer the desired length to the pipe before cutting An apparatus for marking indicia of length and cutting extruded pipe including means for cutting the pipe, means for sensing the speed and position of the pipe, and means for marking on the pipe A similar method and apparatus for manufacturing and/or marking non-extruded linear building materials is also disclosed.

### CROSS-REFERENCE TO RELATED APPLICATIONS

The present application claims the benefit of U.S. provisional application No. 61/133,052 filed Jun. 25, 2008.

### BACKGROUND OF THE INVENTION

1. Technical Field

The present invention relates to building materials that include integral rule markings along their length to facilitate efficient cutting and installation of custom lengths at the point of installation, and a method and apparatus for manufacturing the same.

2. Background Art

Building materials of many types come in linear forms of stock sizes that must be cut to an appropriate length to be installed as part of the construction or repair of a building, structure, or other assembly. Examples of such materials are tiles; flooring planks; ventilation ducts; structural members such as structural panels, beams, channel, angle, rods, bars, rails, rebar, plates, joists, and rafters; trim and molding; lengths of pipe and tubing; and electrical conduit. These building materials are manufactured from a variety of materials such as wood, metal, composite, or clay for example. The present invention can be equally utilized in conjunction with these or other similar building materials although piping will be utilized as an example in this application owing to its widespread and universal use in construction.

Piping of various construction and use is integrated into the mechanical and electrical systems of commercial, residential, and industrial buildings and the infrastructure that ties those buildings to one another and the utilities that service them. Piping is used to bring pressurized water or other liquids and gases to the points they are needed in a building and to carry away the waste. Electrical conduits metal or plastic are commonly used for the similar purpose of directing and protecting electrical runs from the public electric utility to distribution panels and then to fixtures and other devices along a circuit.

A substantial amount of time is consumed during the construction process for installation of these piped systems. Additional time and effort is required to maintain and repair these systems over their life and the life of the building. One of the largest elements of the time consumed is measuring and custom cutting each piece of piping to be joined to and installed with the system. The tolerances required to make these systems water tight and/or sealed as required often necessitate that each piece be field measured and custom cut, particularly with plastic or PVC materials. In other instances, such as with steel piping it is possible to pre-fabricate custom piping offsite for transportation to and installation in a building although to do so efficiently requires significant shop space, equipment and time. Stud walls are only rarely prefabricated offsite and likewise require significant space and equipment accomplish this efficiently.

Again with respect to piping, the onsite custom cutting and installation process requires that a pipe-fitter, plumber, or other mechanic measure each needed pipe length, typically using a tape measure or folding rule, and then transfer that measurement to a stock length of pipe for cutting, again using the tape measure or folding rule, adding or subtracting allowances for various fittings in the process. A similar process is used for other building materials. The use of a tape measure or similar tool to take and make multiple measurements for each length of pipe to be installed introduces multiple points of possible error and is not conducive to high rates of productivity or efficient work. Offsite prefabrication does not eliminate the need to take a measurement because the fabricator merely reads the length needed from a plan drawing or parts list and then measures and marks the stock building material before cutting.

As described, building materials may be made from a variety of materials. For example, piping may be made from metal, plastic, or clay. More specifically, and depending on the location and environment of the installation, substance carried by the pipe, internal pressure, building code, and other factors, piping may be made from black iron (steel), galvanized steel, brass, ductile iron, polyvinyl chloride (PVC), chlorinated polyvinyl chloride (CPVC), polyethylene (PE), cross-linked high-density polyethylene (PEX), polybutylene (PB), and acrylonitrile butadiene styrene (ABS) as well as concrete and ceramics. Although some steel pipe may be rolled and welded or cast, as is some concrete and ceramic pipe, the most common method of manufacturing pipe from these or any other material is by extrusion.

The extrusion process for, as an example, CPVC, begins with raw CPVC material in the form of small beads or pellets, (often referred to as resin or melt) which is gravity fed from a top mounted hopper into the barrel of an extruder. The material enters through a feed throat and comes into contact with a rotating screw that forces the plastic beads forward into the barrel. Pressure and friction from the rotating screw along with externally applied heat gradually heats the resin to its melt temperature softening it into molten form as it is pushed through the barrel of the extruder.

The screw may pressurize and depressurize the resin several times to achieve the desired homogeneous characteristics then passing it through a screen pack to remove any deleterious inclusions before sending it on to the die, where it is given its initial tubular profile. The extruded resin enters a vacuum sizing tank where it is precisely sized to the required outside diameter and then carefully cooled to ensure uniformity of the product. Once cooled the pipe tolerances is monitored to ensure compliance with standards and the extrusion is cut into various standard or customer specified lengths to be bundled and shipped. It is these production lengths that the pipe-fitter is presented with to measure, cut and install on the jobsite.

Currently manufactured pipe is commonly marked by known inkjet or contact imprinting techniques with the name of the manufacturer, a batch number, and/or material specification. Such markings are often provided longitudinally on the surface of the pipe by a passive wheel or jet that continually marks the same coded information over and over in a repeating pattern. Such patterns generally repeat every 3-5 feet along the length of the extrusion such that there is no need to correlate the marking to a specific position on the pipe with respect to an end of the pipe. It is inconsequential if a portion of the code is cut off at the end or beginning of a pipe length because the pattern will simply be repeated in its entirety slightly further along the pipe.

It would be desirable if the manufacturing process of building materials, including pipe, could be adapted to provide regular indicia of length to or from the end or center of the production material length such that the installer, e.g., a pipe-fitter, would not need to use a tape measure to mark the length of a needed section for cutting prior to installation, but rather could read that length pre-marked on the building material and immediately cut accordingly.

It would further be desirable if the manufacturing process of building materials, including pipe manufacturing, could be adapted to accurately place regular indicia of length to or from the end or center of the production material length on an exterior surface of the material without slowing the speed of the production line.

It would further be desirable if the process of marking building material length indicia, including pipe length indicia, during the manufacturing process were easily adapted to varying stock or customer specified lengths of production.

It is thus an object of the present invention to provide a building material length, a pipe length, having pre-marked indicia of distance along its length for quick and accurate cutting of such material during installation.

It is a further object of the invention to provide a method of manufacturing linear building material stock, such as extruded piping, whereby material travel speed and end location may be sensed such that indicia of length to or from an end or center point may be accurately marked on the exterior surface of the material to aid the installer.

### DISCLOSURE OF INVENTION

The foregoing and other objects are accomplished herein by a length of rigid extruded pipe or other linear elomgate building material stock bearing along its outside surface regular indicia of longitudinal distance from a reference point, usually, but not always, an end point, such that an installer need only determine the length of the piece needed (by measurement in the field or from a plan in the shop) and may then immediately locate that position and cut the material to be installed to the desired length without the need to use a measuring device to transfer the desired length to the material before cutting.

There is further provided a method of manufacturing such pre-marked pipe lengths including the steps of feeding pipe raw material stock into the barrel of an extruder, applying heat and pressure to the raw material to bring the material to its melt point, mixing the material to a homogenous consistency, extruding the material through a die, sizing and cooling the extrusion via a vacuum cooling die/chamber, sensing the cut end of the extrusion, marking indicia of the distance from that cut end or other point on an outside surface of the extrusion along the longitudinal axis and cutting the other end of the extrusion in coordination with the applied indicia.

There is further provided a method of manufacturing other pre-marked building material stock lengths including the steps of feeding raw material stock into a conveyor, sensing the ends of the material, determining the length of the piece of material, and marking indicia of the distance from the end(s) or another point on a surface of the material along the longitudinal axis.

There is further provided an apparatus for marking indicia of length and cutting extruded pipe including means for cutting the pipe, usually a travelling chop saw or orbital saw, operating under command of a saw controller, means for sensing the speed and position of the pipe, usually a speed sensing wheel and/or opto-electrical sensor, and means for marking on the pipe, usually an industrial ink-jet printer or contact printer such as a hot print brander.

The foregoing objects, features and attendant benefits of this invention will, in part, be pointed out with particularity and will become more readily appreciated as the same become better understood by reference to the following detailed description of a preferred embodiment and certain modifications thereof when taken in conjunction with the accompanying drawings.

### BRIEF DESCRIPTION OF DRAWINGS

Other objects, features, and advantages of the present invention will become more apparent from the following detailed description of the preferred embodiments and certain modifications thereof when taken together with the accompanying drawings in which:

FIG. 1 is a plain view of pipe bearing indicia of length from a reference point at each end.

FIG. 2 is a detailed view of pipe bearing indicia of length from a reference point at each end.

FIG. 3 is plain view of a typical pipe installation.

FIG. 4 is a schematic view of a method of manufacturing pipe by extrusion and marking such pipe with indicia of length.

FIG. 5 is a schematic view of the cutting and indicia marking apparatus of the present invention.

### BEST MODE FOR CARRYING OUT THE INVENTION

The present invention is a length of generally linear stock building material marked with one or more indicia of distance from a reference point, usually an end of the material, on its exterior surface as well as a method of manufacture thereof. An exemplary embodiment of the present invention, further described herein, is a stock length of extruded pipe marked with indicia of distance from an end or ends of the pipe section on its exterior surface. In a method of manufacturing the exemplary pipe section of the present invention the pipe is marked by an industrial ink-jet printer in cooperative operation with a lateral displacement chop saw employing the method of manufacture disclosed herein. The result is a standard length pipe section accurately marked with length indicia that can be more quickly installed than convention pipe while still employing conventional techniques and which reduces the chance for error and waste over conventional pipe. It is to be understood that the teachings of the present disclosure are equally applicable to other elongate or linear building materials such as tiles; flooring planks; ventilation ducts; structural members such as structural panels, beams, rods, bars, rails, rebar, plates, joists, studs, and rafters; trim and molding; lengths of pipe and tubing; electrical conduit; or the like.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

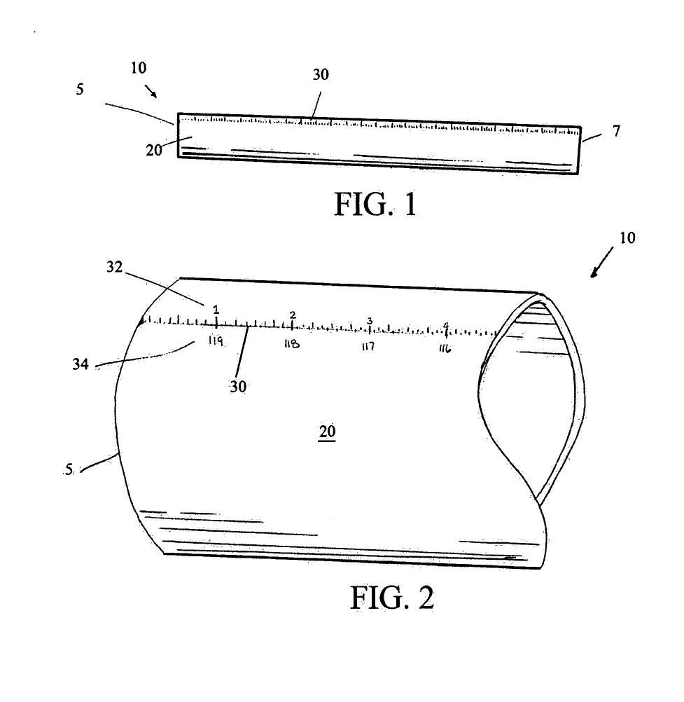

FIG. 1 shows a section of pre-marked pipe 10 according to the present invention. The pipe has a first end 5, a second end 7 and an outer surface 20. Indicia of length 30 are imprinted on the outer surface 20.

FIG. 2 is a detailed partial view of the first end 5 of pipe 10. Pipe 10, in this embodiment of the present invention, is 10 feet (120 inches) long. Indicia 30 along outer surface 20 indicate, on a first scale 32, the axial distance along the length of the pipe from the first end 5, marked off in inches and further delineated in regular intervals as small as 1/16th of an inch. A second scale 34 is further provided indicating the axial distance along the length of the pipe from the second end 7, similarly marked off in inches and further delineated to 1/16th of an inch. It should be understood that additional or alternate scales may be applied indicative of distance from other points such as a midpoint and that form of the indicia may vary and are not limited to roman numerals or U.S. Customary units nor any other specific system of measurement or indicia.

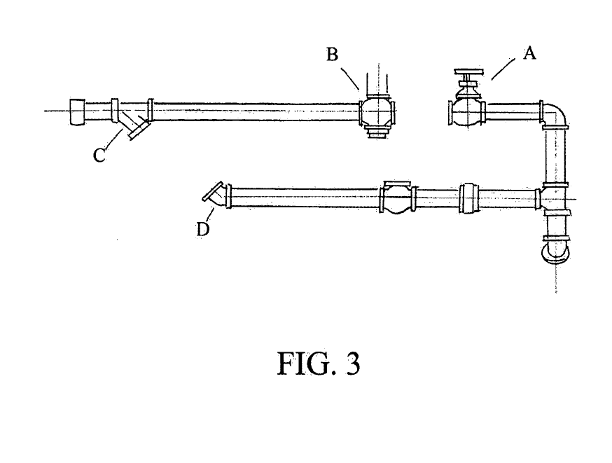

FIG. 3 shows a typical piping system in which a length of pipe is needed between fittings A and B and a second length of pipe is needed between fittings C and D. With conventional pipe an installer would first measure the length of pipe needed between fittings A and B using a conventional tape measure or the like. The installer would then go to his pipe stock and, again using his tape measure, mark the previously measured distance from one end of the pipe. Using a saw or other cutting tool the installer would then cut the pipe at the mark and install the cut piece as required.

Again with reference to FIG. 3 and with further combined reference to FIGS. 1 and 2, utilizing pipe according to the present invention an installer would, as with conventional pipe, measure the length of pipe needed between fittings A and B with a tape measure or the like. The installer would then go to his pre-marked pipe stock and locate the indicia 32 on surface 20 corresponding to the measured length necessary to join fittings A and B. The installer could then immediately cut the pipe at that indicia without the need to utilize his tape measure and be assured that the cut section would be the desired length.

The installer could then measure, with his tape measure or the like, the length of pipe needed between fittings C & D. Returning to the same stock piece of pipe previously cut above, the installer can immediately see, by reference to indicia 34 and without the need to employ his tape measure, if the remaining length is sufficient for use between fittings C & D. If the remaining portion of pipe is long enough to be utilized by the installer, a second length C-D may be cut by utilizing the second scale 34 on face 20 to obtain a desired pipe length as measured from second end 7, again without need to employ a tape measure for marking. If the installer determines that the remaining pipe length is insufficient for the C-D run, he can quickly survey his uncut or partially cut pipe inventory to locate a piece of sufficient length without need of his tape measure by reference to indicia 34 present on each piece in his inventory.

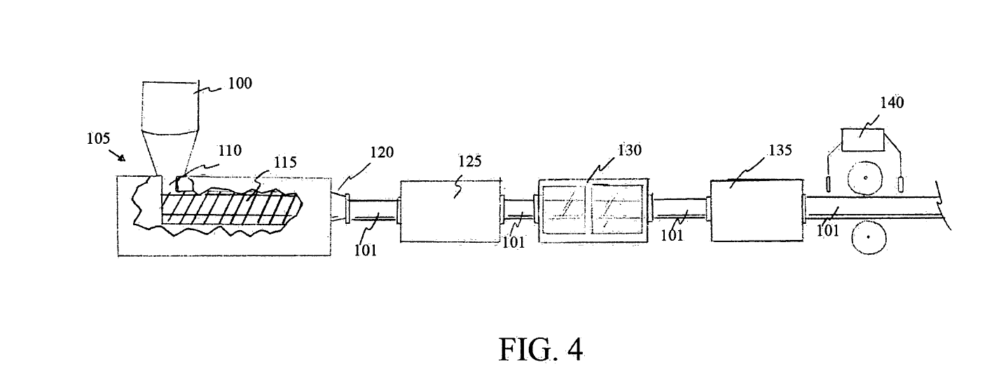

Now with reference to FIG. 4, a method of manufacturing pipe according to the present invention is disclosed. This exemplary embodiment is disclosed with reference to the manufacture of plastic pipe. It is to be understood that this selection of material is not intended to limit the disclosure in any way and alternate embodiments are suitable for use in manufacturing pipe of a variety of materials. Hopper 100 feeds by gravity or vacuum raw PVC or similar material stock, usually in the form of beads, into the barrel 110 of an extruder 105. Screw 115 advances the material through the barrel 110 where it is heated to its melt point and pressurized before being extruded by die 120. The extrusion 101 is immediately fed into a vacuum sizing tank 125 to achieve the proper outside diameter and then carefully cooled to ensure uniformity within allowable tolerances.

Once hardened, extrusion 101 is checked for compliance with pipe wall thickness or other standards at 130. Travelling cut-off saw 135 cuts the extrusion 101 into predetermined lengths and feeds the lengths to ink jet printer 140. Printer 140 includes means to sense the cut ends of the pipe as well as the speed of travel of the pipe in order to calibrate printing such that the marking of indicia of length on the exterior surface correlate properly to their position on that surface relative to the first cut end and the expected second cut end. Depending on the configuration, printing of the indicia will have begun on one end of the pipe before saw 135 has cut the second end, making coordination between the saw and printing means vital to accuracy. In an alternate embodiment of the present method, printing of indicia on the surface of the pipe occurs prior to cutting such that means for sensing the indicia and calibrating the saw cuts with the indicia are incorporated. In another alternate embodiment, printing may be done by a hot print that includes means to calibrate the branding wheel such that the marking of indicia of length on the exterior surface correlate properly to their position on that surface relative to the first cut end and the expected second cut end.

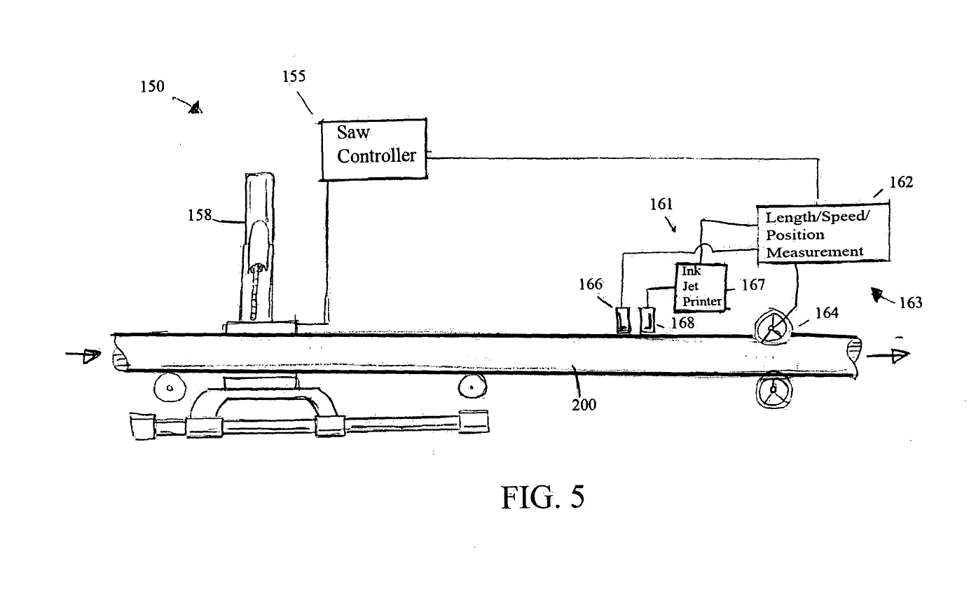

An apparatus for sensing, marking, and cutting an extrusion is also disclosed, as depicted in FIG. 5. The apparatus for printing indicia of distance from one or more ends of the extrusion comprises an extrusion cutting means 150 disposed in a cutting station along an extrusion line. The cutting means comprises a travelling orbital saw or chop saw 158, disposed for receiving a continuous extrusion from an extrusion forming apparatus and, when indicated, matching the speed of and travelling saw 158 in tandem with the extrusion so as to cut the extrusion without need to stop extrusion production. The saw 158 then returning to its original position in preparation for subsequent cutting of the extrusion. Downstream along the extrusion line is provided a means responsive to extrusion speed in the form of an extrusion speed/position measurement device 162 which is of conventional construction and includes two counter wheels 164 disposed one on each side of the extrusion line for engaging opposite sides of extrusion 200 as it moves along. Speed/position measurement device 162 further includes position sensor 166 which may be an opto-electrical sensor for locating the cut ends of the extrusion and computer controller/relay 163 for determining speed and position. The measurement device 162 is connected to a saw control 155 of the cutting means 150 so as to control the operation of the saw. Operation of the saw is engaged by electrical signals received from the measurement device 162.

Downstream from the cutting means 150 but prior to the speed measurement device 162 in this embodiment, is disposed an ink jet printer means 161. Ink jet printer means 161 has an ink jet head 168 and an ink jet printer control 167 which is computer operated. A suitable printer and printer control is that made by Mathews International and is sold as the “I-Mark C84” continuous inkjet printer. The Videojet 43S ink jet printer is similarly suitable as are other models by these manufacturers or others. The printer control 167 is actuated by the speed/position measurement device 162 in conjunction with known constant proximity of the various apparatus elements and selected extrusion length to operate the head 168 at intervals to apply accurate indicia of length to the outside surface of the extrusion.

It should be understood that the invention may be used with a variety of linearly oriented stock building materials and used beyond the realm of extruded pipe manufacturing. Where the method of marking linear materials is implemented in conjunction with already cut lengths, such as with wall studs for example being fed from a mill or otherwise, rather than a continuous extrusion, the cut off saw is, of course, not necessary. In such an instance a second sensor may be employed to initially locate the second end of the individual piece (stud) to be marked as it is advanced through a feeder. In doing so the overall length of the material may be determined and verified for accurate marking with reference to a point other than the first cut end. The addition of a second sensor and/or other means to predetermine and verify the length of the piece to be marked is necessary to permit marking of multiple indicia from, for example, a second end or a center point. This is so because the process no longer has integral control of the material length via coordination with the chop saw. Consequently, while this invention has been described as having an exemplary design and method, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

It is to be understood, therefore, that the invention may be practiced otherwise than as specifically set forth in the appended claims.

### INDUSTRIAL APPLICABILITY

The pre-marked building materials of the present application clearly have a significant industrial advantage in the construction and building industry. Using the present invention, an installer, e.g., a pipe-fitter, would not need to use a tape measure to mark the length of a needed section for cutting prior to installation, but rather could read that length pre-marked on the building material and immediately cut accordingly. The manufacturing method of the present invention also has a clear industrial advantage in the manufacturing industry as the method can be implemented without slowing the speed of the building material production line.

What is claimed is:

1. A stock building material comprising:
a first end;
a second end;
an exterior surface;
a first scale imprinted on said exterior surface whereby the longitudinal distance to said first end is indicated;
a second scale imprinted on said exterior whereby the longitudinal distance to said second end is indicated,
whereby an installer may cut said building material member to a known length without the aid of an external means of measuring said length.

2. The stock building material according to claim 1, wherein said stock building material is an extruded pipe.

3. The stock building material according to claim 2, wherein said stock building material is PVC pipe.

4. The stock building material according to claim 2, wherein said stock building material is metal pipe.

5. The stock building material according to claim 1, wherein said stock building material is wood.

6. The stock building material according to claim 1, wherein said stock building material is a linear stock building material having a primary longitudinal axis.

7. An elongate building material member having a first end, a second end, and a substantially uniform body defined by a primary longitudinal axis running from said first end to said second end, said uniform body having an exterior surface, and at least one scale imprinted on said exterior surface whereby the longitudinal distance from a predetermined point on the surface of the pipe between and including said first end and said second end is indicated.

8. The elongate building material member according to claim 7, wherein said stock building material is an extruded pipe.

9. A method of manufacturing pre-marked extruded building material comprising the steps of:
extruding a linearly continuous section of material;
selecting a stock length into which said continuous section of material will be cut;
cutting a first end of said material;
cutting a second end of said material;
sensing said first cut end;
marking a first scale including a plurality of indicia indicting distance along a surface of said material, said first scale indicating distance from said first end of said material.

10. The method of manufacturing pre-marked extruded building material according to claim 9, further comprising a step of marking a second scale including a plurality of indicia indicting distance along a surface of said material, said second scale indicating distance from said second end of said material.

11. The method of manufacturing pre-marked extruded building material according to claim 9, further comprising a step of verifying said first scale accurately indicates said distance.

12. The method of manufacturing pre-marked extruded building material according to claim 9, wherein said building material is extruded pipe.

13. An apparatus for pre-marking an extrusion comprising:
a cutting means disposed on an extrusion line;
a sensor for sensing a first end and a second end of said extrusion cut by said saw;
a sensor for sensing the speed at which said extrusion is being extruded;
a printer means operable to print indicia of length from at least one reference point along said extrusion;
whereby said cutting means and said printing means operate in coordinated cooperation to accurately print said indicia of length in response to signals from said sensing means.

14. An apparatus for pre-marking an indicia of length on a linear stock building material having a primary longitudinal axis comprising:
conveying means for advancing said linear stock building material along its longitudinal axis;
a first sensor for sensing a first end of said linear stock building material;
a second sensor for sensing a second end of said linear stock building material;
a sensor for sensing the speed at which said material is advanced;
a printer means operable to print indicia of length from at least one reference point along said material;
whereby said advancing means and said printing means operate in coordinated cooperation to accurately print said indicia of length in response to signals from said sensing means.
